(19) United States
(12) Patent Application Publication
(10) Pub. No.: US 2011/0297588 A1
(43) Pub. Date: Dec. 8, 2011

(54) METAL FRAMEWORKS FOR SCREENING MESHES MADE OF POLYURETHANE OR OTHER SYNTHETIC MATERIAL

(76) Inventor: Cayo Munoz Corral, Zaragoza (ES)

(21) Appl. No.: 13/130,132

(22) PCT Filed: Nov. 18, 2009
(86) PCT No.: PCT/ES2009/070512

§ 371 Date: Aug. 26, 2011

(30) Foreign Application Priority Data
Nov. 19, 2008 (ES) U 200802385

(51) Int. Cl. B07B 1/46

(52) U.S. Cl. 209/408

(57) ABSTRACT

As indicated in the title, this description relates to an improved metal framework, including several hooks, the ends of which are interconnected with a single cable threaded behind the tensioning hooks that is subsequently covered with a layer of polyurethane or another type of synthetic material, creating a vibration classification screening mesh unit, the polyurethane and the shape of the specially prepared mould in which the tensioning hooks and the cable both covered by the polyurethane mesh act as metal elements, helping to prevent the elastic deformations of the synthetic mesh and providing a robust consistency.

### FIELD OF THE INVENTION

As indicated in the title, this description relates to an improved metal framework, including several hooks, the ends of which are interconnected with a single cable threaded behind the tensioning hooks that is subsequently covered with a layer of polyurethane or another type of synthetic material, creating a classification by vibration screening mesh unit, the polyurethane contributing the shape of the specially prepared mould in which the tensioning hooks and the cable both covered by the polyurethane mesh act as metal elements, helping to prevent the elastic deformations of the synthetic mesh and providing a robust consistency.

### BACKGROUND OF THE INVENTION

The state of the art of screening meshes for classification by vibration of aggregates or mining materials are firstly related to rigid metal meshes and also currently with meshes made of synthetic materials such as polyurethane internally reinforced with metal mesh, or using individual steel cables attached like slings with complicated assembly using the attachment hooks which are coupled to the vibration machine, there are also reinforcements based on rigid rods mechanically joined to the attachment hooks, even if all these systems perform a function, the problem exists that the individual steel cables have difficulties of attachment when exerting tension upon sharp edges and the individual tension unbalances the mesh unit, with respect to the metal meshes it is proved that their performance and working hours are noticeably lower than the screening meshes made of synthetic materials, also known as state of the art the Spanish Utility Model No. U200800787 “Framework support with tensioning hooks and cable integrated into a screening mesh made of polyurethane or other synthetic materials” by Inelas Poliuretanos, S. L. which has considerably improved the practicality of metal frameworks, but has the problem that when tensioning the mesh over the screen the cable exerts a direct force on the tensioning hooks, which produces a slight inclination and although it performs the function of screening, with an improvement which further on we will disclose, we will improve and expand without any deformations at all its function of clamping on the screen.

### SUMMARY OF THE INVENTION

The object of the present invention as described herein is to provide a framework support with tensioning hooks and cable to be integrated in a screening mesh made of polyurethane or other synthetic materials with which we solve or improve the previously mentioned problems in a simple way and with low cost assembling. This assembling is carried out with tensioning hooks, bent at an acute angle and setting, situated at both ends of the hooks, a single cable which is interconnected from one hook to another through orifices laid out like a comb on the shortest side of the angle, while the longest side has oblong holes in a figure of eight with curved ends and of a larger size, which connect on one side of the end with a slot to thread the single cable when passed through the oblong hole in a figure of eight and to pass it through the interior of the tensioning hook, this cable will reach a distance of passage in accordance with the size of the classification mesh. The distance between the tensioning hooks is obtained using provisional assembly wedges which maintain the determined distance fixed between the hooks and thus the positioning of the cable can begin by fixing it to the initial hook with the sending of the cable itself to the opposite hook, passing through one orifice to another threading through the slot and changing from one side of the hook to the other using the oblong hole, next the cable returns to the initial hook and so on successively until completing in parallel the whole surface of the framework, the single end cable of which remains trapped by the cables themselves centred in the end orifices of the corresponding tensioning hook. The leading of the cable along its complete course is carried out using the lower and exterior part, except when passing through the oblong holes in a figure of eight, wherein said cable passes through the interior of the hooks which have a wide radius which eliminates all possibility of cutting, and the same applies to the holes for the passage of the cable which have a rounded edge preventing sharp edges, both in the comb type holes and the oblong holes in a figure of eight. It has been proved in laboratory resistance testing that in the oblong holes in the form of a comb when passings are done are made, the cable has less than about five times the tension which is found between the hooks according to the laws of physics with cables rolled into a drum, playing the exterior bend of the tension load the role of a drum. An important feature is that the position of the cables allows them to be centered to the left or right precisely on the mould before applying the polyurethane or synthetic resin, equally allowing the number of passings of the cable between the hooks to be increased easily and at low cost in order to achieve the sufficient total tension force without risk of breakage. An added advantage is that the polyurethane or resin completely covers the metal framework which, as already mentioned, is composed solely of the two tensioning hooks with their corresponding holes and single cable.

### BRIEF DESCRIPTION OF THE DRAWINGS

To complete the description that is being made and with the object of assisting in a better understanding of the characteristics of the invention, accompanying said description as an integral part thereof, is a set of drawings wherein, where by way of illustration and not restrictively, the following has been represented:

FIG. 1 is a screening mesh unit (1) showing the interconnections of the cable (3), in correspondence with the tensioning hooks (2), displaying a schematically cutaway detail of the sieve (4).

FIG. 2 corresponds to the longitudinal cross section of the mesh unit (1), an end is sectioned at the area where the cable (3) passes while at the other end the section crosses the mesh (4) where the calibrated holes of the sieve (4.1) are situated.

FIG. 3 comprises a perspective view of the mesh itself (4) where the holes (4.1) can be observed which classify the size (P) of the aggregates and other products to be screened.

FIG. 4 is a perspective view with the detail of an end of the tensioning hook (2), in which on the holes laid out in the form of a comb (2.1) is interconnected the single cable (3), to continue threading it through the path of a slot (2.4) with a width slightly greater than the diameter of the cable to the oblong hole (2.5) and alternatively with the holes of the opposing tensioning hooks with the same procedure and with the distance or passage (P) in accordance with the mesh, observing the generous radius (2.3) and the round edges (2.2) of the different holes where the cable (3) exerts pressure.

FIG. 5 comprises an enlarged cross sectional view of the holes (2.1 and 2.5) in which the spaces for cable positioning are rounded (2.2), to impede the cutting effect of the tensioned cable (3), also the passage of the cable (3) can be observed, through the oblong hole in a figure of eight (2.5) passing from the exterior side of the pressure hook to its interior side.

FIG. 6 contains a plan view with the development of the metal sheet of the pressure hook (2) of the metal framework before being bent, the holes in the form of a comb (2.1) can be observed while at the other end the oblong hole in a figure of eight (2.5) all of which with the edges (2.2), to complete the figure are the slots (2.4) with a greater width than the diameter of the cable, which allow the threading of the single cable (3) of the mesh.

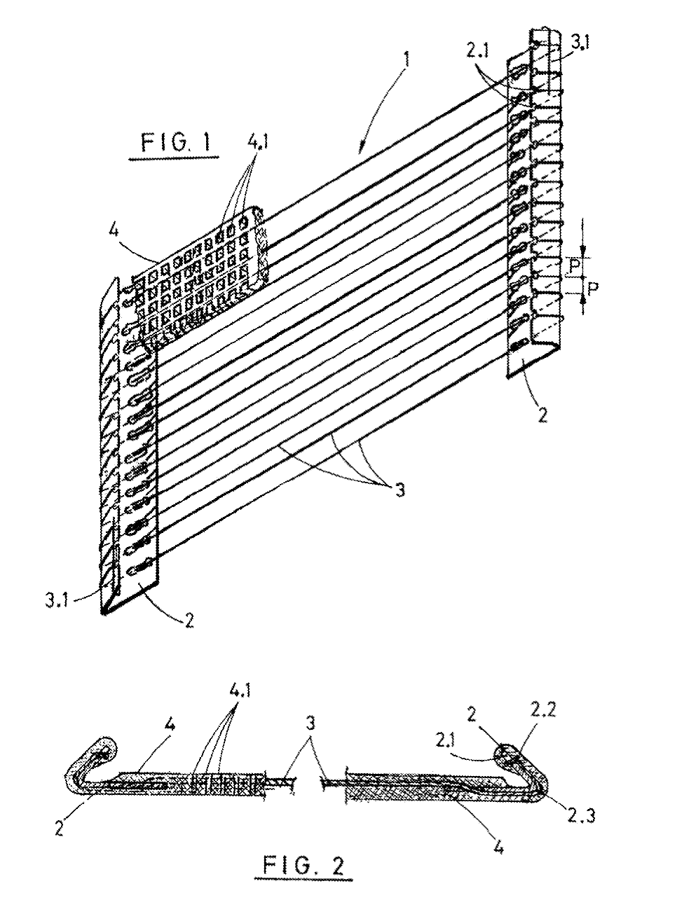

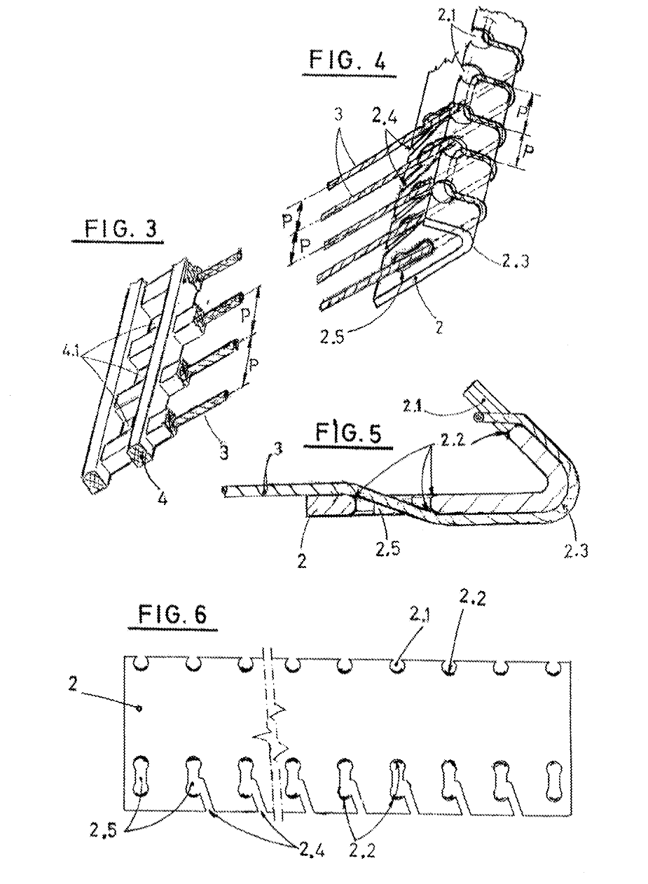

These figures are related to the following alphanumerical references:

1.—Screening mesh unit.

2.—Tensioning hooks or clamps.
2.1.—Register holes of the cable.
2.2.—Rounded edges on both sides of the orifices.
2.3.—Detail of the wide radius in the bend of the hook or clamp.
2.4.—Threading slot.
2.5.—Almond-shaped hole in a figure of eight.

3.—Single reinforcing cable of the mesh.
3.1.—Attachment for the beginning and termination cable ends.

4.—Classification sieve of the mesh made of polyurethane or synthetic resin.
4.1.—Sieve holes of the screening mesh.

“P”.—Passage of the parallel distribution of the single cable.

### DETAILED DESCRIPTION OF THE INVENTION

In view of these figures and alphanumerical references, the simple embodiment can be seen of the screening mesh unit (1) comprising the independent manufacture of the tensioning hooks or clamps (2), composed of a sheet of metal bent at an acute angle and wide radius of bend with uneven sides and which has on the shorter side open orifices (2.1) that are parallel and equidistant, each comprising a rounded edge (2.2) on the interior and exterior, while on the longer side on the acute angle there are oblong holes (2.5) in a figure of eight, also with the perimeters of contact with the cable having a rounded edge (2.2), in addition to slots (2.4), with a slightly greater width than the diameter of the cable (3), which allows it to be threaded and to pass from the exterior side to the interior, preventing force being exerted on the tensioning hook upon tensioning the mesh into the working position with the screen; on the other hand the location of the holes (2.1 and 2.5) with the passage (P) are those which determine the position of the holes (4.1) classifying the size of the aggregates or other materials to be screened which are deposited on the screening mesh (4). On an assembly table there is a tensioning hook (2) fitted on each side in accordance with the desired length of the screening mesh and using provisional assembly wedges allow the desired distance to be maintained and to begin the assembly or threading of the single cable, whose initial end remains fixed (3.1) by the cable itself in its travel in one way and the other through the open orifices (2.1) with passage (P) passing through the oblong holes (2.5) changing the cable from the exterior to interior sides of the tensioning hooks or clamps (2), and as a result we prevent exerting the direct stress of the tensioning force be it supported by the wing which is provided by the tensioning hook itself, passing from both the cable (3) at one end to the other through the open orifices (2.1), forming a comb crossing the oblong holes (2.5), all these holes have rounded edges (2.2), this cable (3) passes from one hole to another in parallel with passage (P) determined by the screening mesh sieve (4) until the whole area of the framework has been completed, the final end of which remains fixed (3.1) by the cables themselves centred through the final holes of the corresponding tensioning hooks (2). Finally on the total surface area of this unit the mould is fitted which allows us to manually position the cables into the correct position before applying the polyurethane or synthetic resin.

In the case of the hooks or clamps (2) the materials will preferably be laminated steel stamped sheet metal bent with a generous radius while the cable (3) will be commercial steel with interconnected threads, the sieve of the mesh (4) will be treated with synthetic material, preferably polyurethane.

The nature of the invention sufficiently disclosed herein, taking into account the terms which have. been drafted must be taken in a wide and not restrictive sense, in addition to the disclosure of the way carrying it out and demonstrating that it comprises a positive advancement in the state of the art in the manufacture of improved metal frameworks for screening meshes made of polyurethane or other synthetic materials, therefore application is sought for patent protection, the essence of the invention referred to being as specified below in the following claims.

1. A metal framework unit for screening meshes employed as an interchangeable accessory in vibrating screening machines and which select and calibrate different aggregates or mining materials according to the passage and hole of a sieve, the metal framework unit comprising:
a tensioning hook at each end composed of a sheet of laminated steel, bent at an acute angle with a wide bend radius and with uneven sides, wherein a shorter side has open orifices, forming a comb with distance determined by the holes of the sieve of the mesh, while a longer side of the angle there are oblong holes in a figure-eight shape which on their end part have a slot extended to the exit of the metal sheet with a slightly greater width than the diameter of the cable, this set of tensioning hooks remain interconnected by a single cable forming the metal framework unit,
wherein the metal framework unit is covered with a layer of polyurethane or other synthetic material.

2. The metal framework unit of claim 1, wherein the threading of the single cable remains fixed by the cable itself in its travel one way and the other by way of the set of tensioning hooks, through their open orifices with passage passing through the oblong holes which makes the cable change from the exterior to the interior sides of the pressure hooks, passing the cable from one end to another through the open orifices.

3. The metal framework unit of claim 1, wherein both the open orifices and the oblong holes in the figure-eight shape of the tensioning hooks have rounded edges.
